(19) United States
(12) Patent Application Publication
(10) Pub. No.: US 2002/0087311 A1
(43) Pub. Date: Jul. 4, 2002

(54) Computer-implemented dynamic language model generation method and system

(76) Inventors: Victor Wai Leung Lee, Waterloo (CA); Otman A. Basir, Kitchener (CA); Fakhreddine O. Karray, Waterloo (CA); Jiping Sun, Waterloo (CA); Xing Jing, Waterloo (CA)

Correspondence Address: Jones, Day, Reavis and Pogue, North Point, 901 Lakeside Avenue, Cleveland, OH, 44114, US

(21) Appl. No.: 09/863,738

(22) Filed: May 23, 2001

Related U.S. Application Data
(60) Provisional application No. 60/258,911, filed on Dec. 29, 2000.

(51) Int. Cl. G10L 15/04

(52) U.S. Cl. 704/251

(57) ABSTRACT

A computer-implemented system and method for speech recognition of a user speech input. A plurality of language models contains words belonging to domains at different levels of specificity. A recognition unit recognizes words of the user speech input through use of the different language models. A dynamic language model generation unit generates a dynamic language model from the recognized words by examining both semantic and phonetic information of the recognized words. The dynamic language model is used to recognize the words in the user speech input.

### RELATED APPLICATION

This application claims priority to U.S. provisional application Ser. No. 60/258,911 entitled “Voice Portal Management System and Method” filed Dec. 29, 2000. By this reference, the fall disclosure, including the drawings, of U.S. provisional application Ser. No. 60/258,911 are incorporated herein.

### FIELD OF THE INVENTION

The present invention relates generally to computer speech processing systems and more particularly, to computer systems that recognize speech.

### BACKGROUND AND SUMMARY OF THE INVENTION

Previous speech recognition systems have been limited in the size of the word dictionary that may be used to recognize a user's speech. This has limited the scope of such speech recognition system to handle a wide variety of user's spoken requests. The present invention overcomes this and other disadvantages of previous approaches. In accordance with the teachings of the present invention, a computer-implemented system and method are provided for speech recognition of a user speech input. A plurality of language models contains words belonging to domains at different levels of specificity. A recognition unit recognizes words of the user speech input through use of the different language models. A dynamic language model generation unit generates a dynamic language model from the recognized words, and the dynamic language model is used to recognize the words in the user speech input.

Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a system block diagram depicting the software-implemented components used by the present invention to perform speech recognition;

FIG. 2 is a flowchart depicting the steps used by the present invention to perform speech recognition;

FIG. 3 is a flow diagram depicting an example of the present invention in handling user request;

FIG. 4 is a block diagram depicting the web summary knowledge database for use in speech recognition;

FIG. 5 is a block diagram depicting the phonetic knowledge unit for use in speech recognition;

FIG. 6 is a block diagram depicting the conceptual knowledge database unit for use in speech recognition; and

FIG. 7 is a block diagram depicting the popularity engine database unit for use in speech recognition.

### DETAILED DESCRIPTION OF THE PREFERRED EMBODIMENT

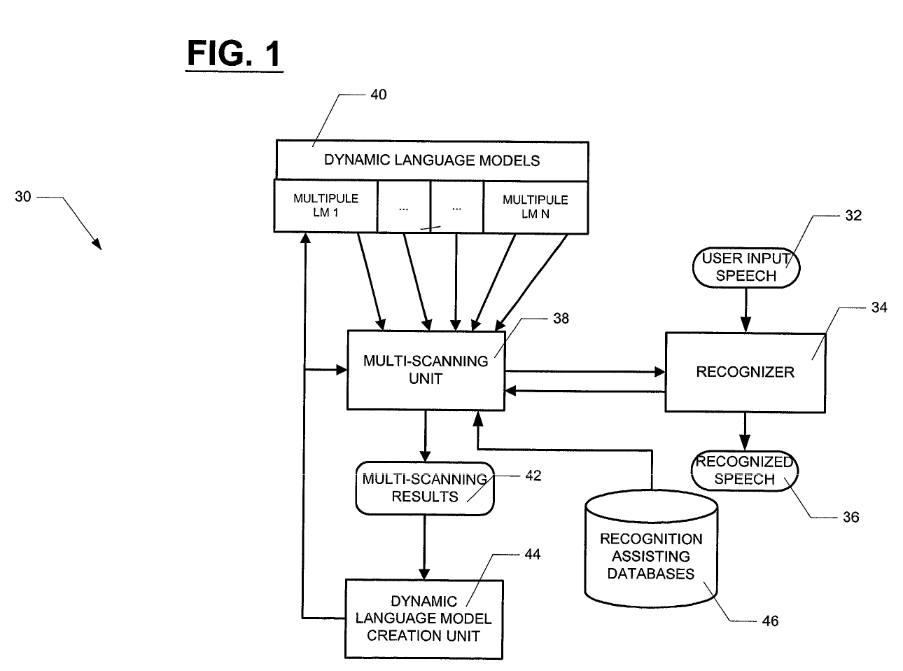

FIG. 1 is a system block diagram that depicts the dynamic language model creation system 30 used by the present invention to perform speech recognition. With reference to FIG. 1, the dynamic language model creation system 30 allows a speech recognition computer platform generate new language models dynamically in real time with data from web sites, databases, and user history profiles. The system 30 creates predictions about a user request 32. As the user voices a request 32, a multi-scanning unit 38 scans multiple language models 40 for word recognition. It detects words in the user utterance 32 that are contained in the language models 40. The multiple language models 40 contain domain specific terms scanned by the multi-scanning unit 38 when decoding a user utterance. Some words in the utterance are recognized as noise and eliminated by the recognition unit because the dynamic language model generation unit 44 can reduce false recognition by eliminating irrelevant words. Other words in the language models 40 are not part of the utterance, and are discarded. Some falsely mapped words may occur in the individual word recognition results because the recognition results may contain words that sound similar to words in the utterance. All recognized words go into a real time, dynamically created language model. With this smaller subset, the multi-scanning unit 38 has a greater probability of accurate word mapping.

The multi-scanning unit 38 scans multiple language models 40 for words detected by the speech recognition unit 34. The multi-scanning unit 38 detects units of speech in multiple language models 40 and relays its results 42 to the dynamic language model generation unit 44. The dynamic language model generation unit 44 retains examples of user utterances and calculates probabilities of typical requests, thereby enhancing the accuracy of recognition.

For example, if the user requested cheap air tickets for a USAir flight from San Francisco to New York on Monday, the dynamic language model creation unit 44 compiles N-best recognition results from the multi-scanning unit to form a dynamic language model from which further scanning can eliminate the falsely mapped words with greater accuracy. When a certain number of key words are recognized, the falsely mapped words can be removed by the dynamic model unit as it builds a conceptually based dynamic language model. The dynamically created model may be continually updated as the multi-scan control unit iteratively selects and applies more specific models from the multi-language models to recognize additional words. The recognized additional words are added to the dynamic language model. Greater accuracy is also achieved by eliminating words irrelevant to the database, such as social idioms (“please”, “thank you” etc.).

The present invention may utilize recognition assisting databases 46 to further supplement recognition of the user speech input 32. The recognition assisting databases 46 may include what words are typically found together in a speech input 30. Such information may be extracted by analyzing word usage on Internet web pages. Another exemplary database to assist word recognition is a database that maintains words that already have been recognized for a particular user or for users that have previously submitted requests which are similar to the request at hand. Other databases to assist in words recognition are discussed below.

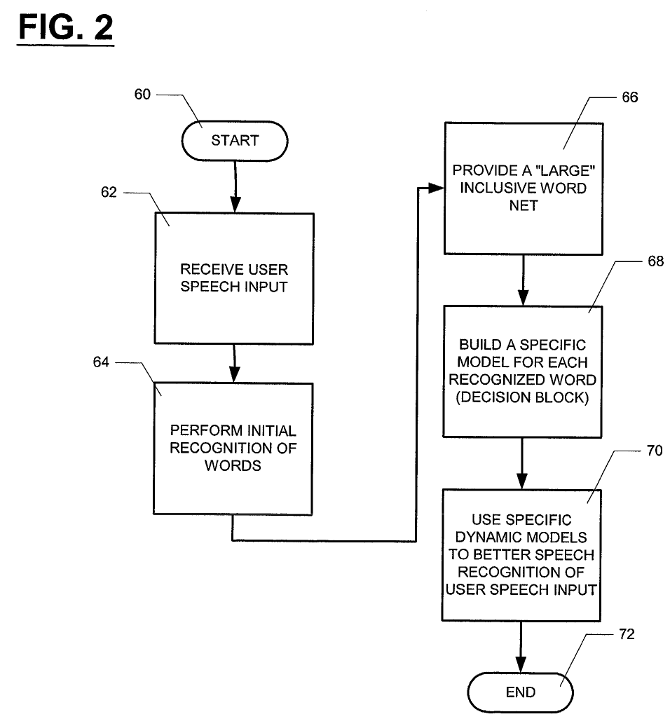

FIG. 2 is a flowchart depicting the steps used by the present invention to perform speech recognition. With reference to FIG. 2 start block 60 indicates that process block 62 is first executed. At process block 62, the user speech input is received by the present invention, and process block 64 performs an initial recognition of the words. Process block 66 provides a “large” inclusive word net so that process block 68 may build a specific model for each of the recognized words. The specific models that result from process block 68 are used in order to increase the accuracy of the speech recognition of the user speech input. Process block 68 utilizes a decision procedure for the dynamic model building. The decision procedure first receives multiple hypotheses of initial recognition, which are determined from multiple scans of the input user speech with different language models. Each scanning may also utilize the N-best search procedure of the HMM engine of the recognizer to generate multiple word strings. The decision procedure, utilizing a neural network predictor, decides how many template slots (concepts) will be built into the new dynamic model, how many words will be used on each slot and the depth of network. The trained predictor builds the dynamic model by considering such information as the conceptual group of the recognized words, their phonetic features and the known probabilities of the words. Processing terminates at end block 72.

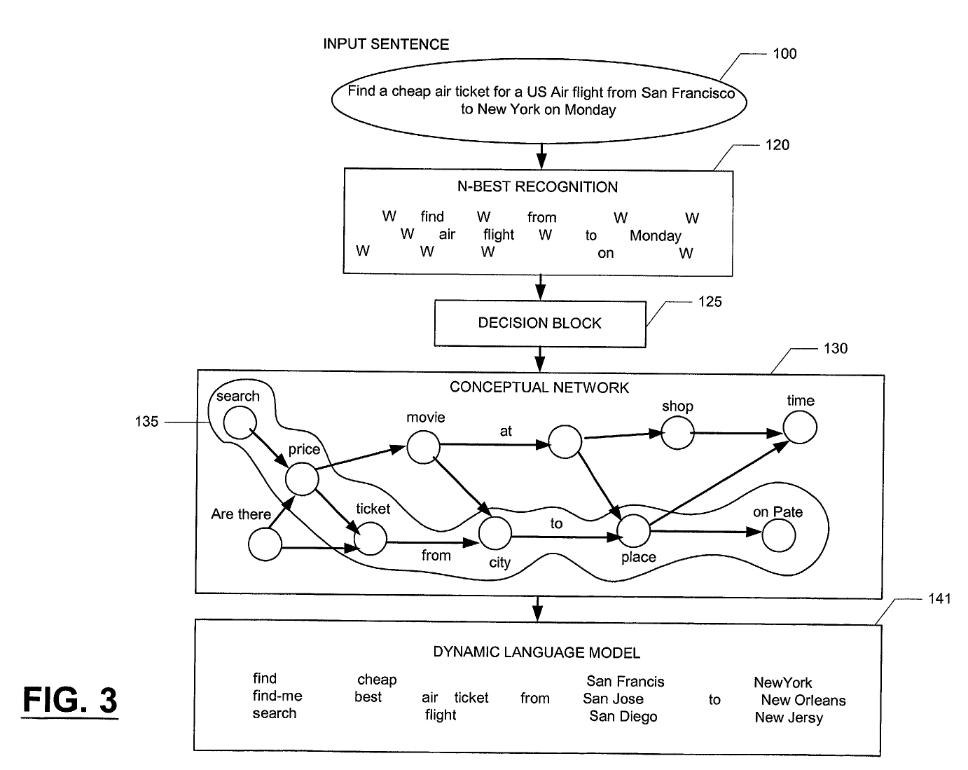

As an example of the present invention and with reference to FIG. 3, the dynamic model creation process is evaluated in light of the present invention. The user requests for specific information 100 “find a cheap air ticket for a USAir flight from San Francisco to New York on Monday”. Using a “large”, general language model, some words may get falsely mapped, while a certain percentage of the words can be expected to be correctly recognized. This results in a word lattice hypothesis 120. Based on this, a decision block 125 utilizes artificial neural network technology to combine semantic and phonetic information, so that accurate predictions of the user interest can be made. The decision block 125 searches in a conceptual network 130 to find the correct conceptual pattern 135, and using that pattern builds a sufficient language model 141. The decision making technique is unique in combining semantic and phonetic information so that the two types of information mutually supplement each other. For example, if the conceptual pattern is the correct one that is intended by the user, then the correctly recognized words can find its semantic feature compatible to some conceptual nodes of the pattern. At the same time the falsely mapped words can find their phonetic feature compatible to some nodes or their subsets. These subsets are the result of partitioning according to phonetic similarity in order to further reduce the size of the dynamic language model.

With the use of the dynamic language model the high accuracy recognition result can be achieved. Dynamic language model creation technology allows quicker responses to user requests and more flexible comprehension of unique utterances. The user does not need to memorize commands, but can generate novel utterances and be understood.

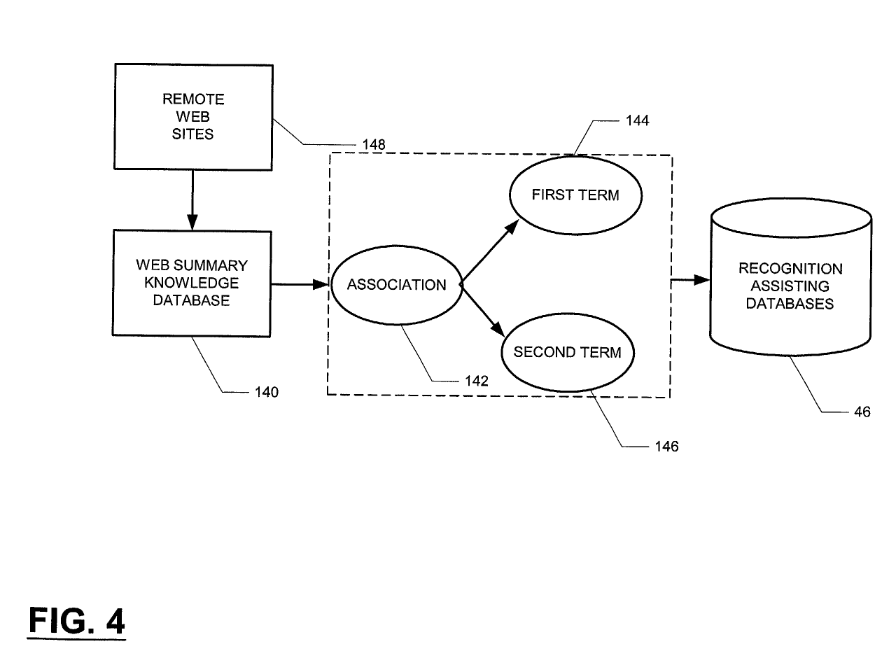

FIG. 4 depicts the web summary knowledge database 140 that forms one of the recognition assisting databases 46. The web summary information database 140 contains terms and summaries derived from relevant web sites 148. The web summary knowledge database 140 contains information that has been reorganized from the web sites 148 so as to store the topology of each site 148. Using structure and relative link information, it filters out irrelevant and undesirable information including figures, ads, graphics, Flash and Java scripts. The remaining content of each page is categorized, classified and itemized. Through what terms are used on the web sites 148, the web summary database 140 forms associations 142 between terms (144 and 146). For example, the web summary database may contain a summary of the Amazon.com web site and creates an association between the term “golf” and “book” based upon the summary. Therefore, if a user input speech contains terms similar to “golf” and “book”, the present invention uses the association 142 in the web summary knowledge database 140 to heighten the recognition probability of the terms “golf” and “book” in the user input speech.

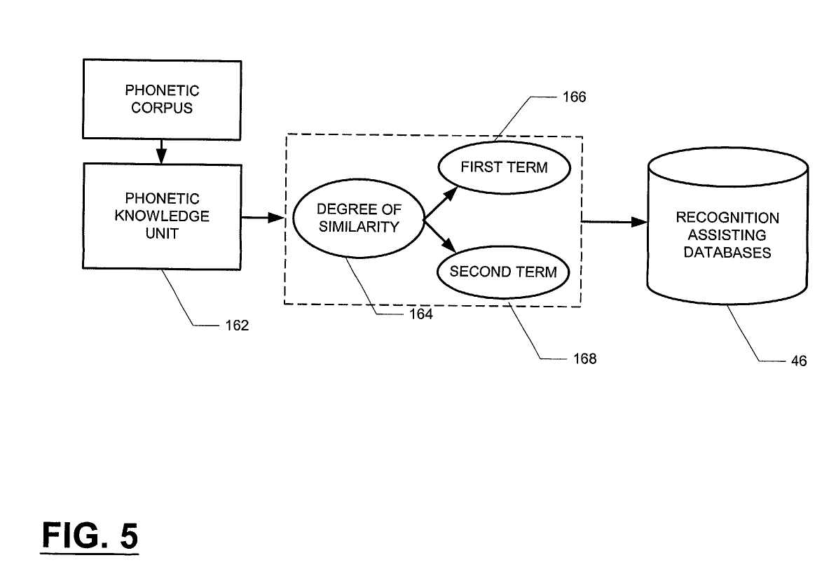

FIG. 5 depicts the phonetic knowledge unit 162 that forms one of the recognition assisting databases 46. The phonetic knowledge unit 162 encompasses the degree of similarity 164 between pronunciations for distinct terms 166 and 168. The phonetic knowledge unit 162 understands basic units of sound for the pronunciation of words and sound to letter conversion rules. If, for example, a user requested information on the weather in Tahoma, the phonetic knowledge unit 162 is used to generate a subset of names with similar pronunciation to Tahoma. Thus, Tahoma, Sonoma, and Pomona may be grouped together in a node specific language model for terms with similar sounds. The present invention analyzes the group with other speech recognition techniques to determine the most likely correct word.

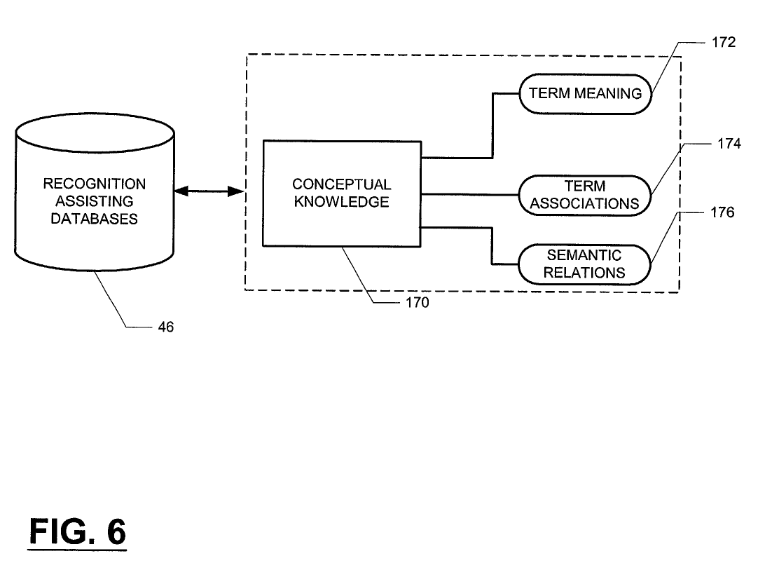

FIG. 6 depicts the conceptual knowledge database unit 170 that forms one of the recognition assisting databases 46. The conceptual knowledge database unit 170 encompasses the comprehension of word concept structure and relations. The conceptual knowledge unit 170 understands the meanings 172 of terms in the corpora and the conceptual relationships between terms/words. The term corpora means a large collection of phonemes, accents, sound files, noises and pre-recorded words.

The conceptual knowledge database unit 170 provides a knowledge base of conceptual relationships among words, thus providing a framework for understanding natural language. For example, the conceptual knowledge database unit contains associations 174 between the term “golf ball” with the concept of “product”. As another example, the term “Amazon.com” is associated with the concept of “store”. These associations are formed by scanning web sites, thus obtaining conceptual relationship between words, categories and their contextual relationship within sentences.

The conceptual knowledge database unit 170 also contains knowledge of semantic relations 176 between words, or clusters of words, that bear concepts. For example, “programming in Java” has the semantic relation: [Programming-Action]-<means>[Programming-Language(Java)].

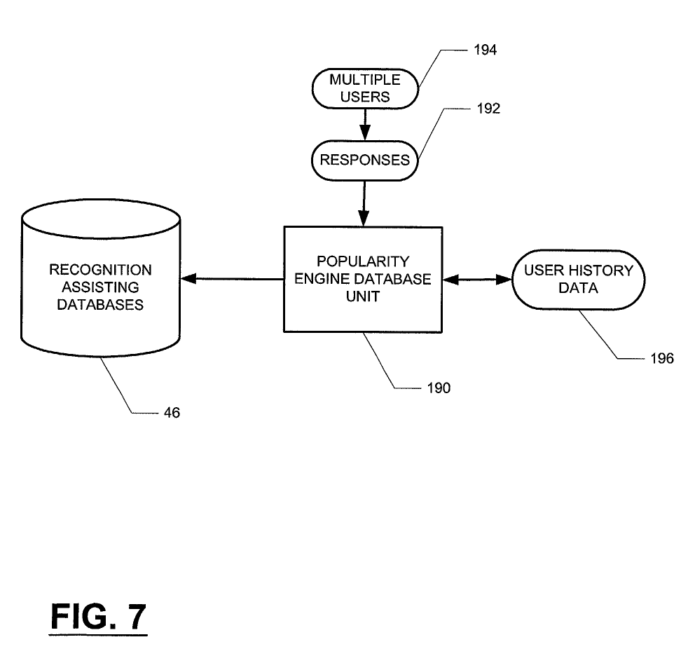

FIG. 7 depicts the popularity engine database unit 190 that forms one of the recognition assisting databases 46. The popularity engine database unit 190 contains data compiled from multiple users' histories that has been calculated for the prediction of likely user requests. The histories are compiled from the previous responses 192 of the multiple users 194. The response history compilation 196 of the popularity engine database unit 190 increases the accuracy of word recognition. Users belong to various user groups, distinguished on the basis of past behavior, and can be predicted to produce utterances containing keywords from language models relevant to, for example, shopping or weather related services.

The preferred embodiment described within this document with reference to the drawing figures is presented only to demonstrate an example of the invention. Additional and/or alternative embodiments of the invention will be apparent to one of ordinary skill in the art upon reading this disclosure.

It is claimed:

1. A computer-implemented system for speech recognition of a user speech input, comprising:
a plurality of language models that contains words belonging to domains at different levels of specificity;
a recognition unit connected to the language models that recognizes words of the user speech input through use of the different language models; and
a dynamic language model generation unit connected to the recognition unit that generates a dynamic language model from the recognized words by examining both semantic and phonetic information of the recognized words;
wherein the dynamic language model is used to recognize the words in the user speech input.

2. The system of claim 1 wherein the language models form a hierarchy that progresses from general terms to specific terms is used to recognize the utterances from the user speech input.

3. The system of claim 2 wherein the language models regard domains, wherein hierarchy of language models is organized based upon the domain to which a language model is directed.

4. The system of claim 3 wherein the language models are hidden Markov language recognition models.

5. The system of claim 3 wherein the recognized words are provided to an electronic commerce transaction computer server in order to process request of the user input speech.

6. The system of claim 1 further comprising:
a web summary knowledge database connected to the recognition unit that stores associations between first terms and second terms, wherein the associations indicate that when a first term is used its associated second term has a likelihood to be present, wherein Internet web pages are processed in order to determine the associations between the first and second terms, wherein the recognition unit uses the stored associations to recognize the utterances within the user input speech.

7. The system of claim 1 further comprising:
a phonetic knowledge unit connected to the dynamic language model generation unit that stores the degree of pronunciation similarity between a first and second term, wherein the phonetic knowledge unit is used to select terms of similar pronunciation for storage in the second language model, wherein the dynamic language model generation unit uses the stored pronunciation similarity to identify words to add to the dynamic language model.

8. The system of claim 1 wherein a conceptual knowledge database unit stores word concept structure and relations, wherein the stored word concept structure and relations are used by the recognition unit to recognize the words within the user input speech.

9. The system of claim 1 wherein the recognition unit includes multi-scanning means.

10. The system of claim 1 wherein the recognized words are used within a telephony system.
